(19) United States
(12) Patent Application Publication
(10) Pub. No.: US 2023/0213988 A1
(43) Pub. Date: Jul. 6, 2023

(54) SIDE-BAND COOLING CONFIGURATION FOR TRAPPED IONS

(71) Applicant: IonQ, Inc., College Park, MD (US)

(72) Inventors: Shantanu DEBNATH, Lanham, MD (US); Jason Hieu Van Nguyen, Hyattsville, MD (US); Peter Lukas Wilhelm Maunz, Albuquerque, NM (US); Kevin Antony Landsman, Rockville, MD (US); Hermann Uys, Annapolis, MD (US)

(21) Appl. No.: 18/148,052

(22) Filed: Dec. 29, 2022

Related U.S. Application Data
(60) Provisional application No. 63/295,102, filed on Dec. 30, 2021.

(51) Int. Cl. G06F 1/20; G06N 10/40; G21K 1/00

(52) U.S. Cl. CPC G06F 1/206; G06N 10/40; G21K 1/00

(57) ABSTRACT

A system and method is provided for use in the implementation and/or operation of quantum information processing (QIP) systems, and more particularly, to design or configure an optimal side-band cooling operation for trapped ions. A method is described that involves applying a first cooling operation on the trapped ion chain and subsequently applying a second cooling operation on the trapped ion chain that includes applying to each cooling ion in the trapped ion chain, as part of a side-band cooling pulse sequence, at least one analysis pulse followed by a corresponding batch with one or more side-band cooling pulses, wherein each analysis pulse is configured to determine a detuning and pulse duration of the one or more side-band cooling pulses of the corresponding batch. A quantum computer or QIP system is also described that enables the operation of the method described above.

### PRIORITY

This application claims priority to and the benefit from U.S. Provisional Application No. 63/295,102, filed on Dec. 30, 2021, and titled “Side-Band Cooling Configuration for Trapped Ions,” the contents of which are incorporated herein by reference in their entirety.

### TECHNICAL FIELD

Aspects of the present disclosure relate generally to systems and methods for use in the implementation, operation, and/or use of quantum information processing (QIP) systems.

### BACKGROUND

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, control, and/or functionality of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of the design or configuration of an optimal side-band cooling operation for trapped ions.

A method for side-band cooling a trapped ion chain is described that involves applying a first cooling operation on the trapped ion chain and applying, after the first cooling operation, a second cooling operation on the trapped ion chain that includes applying to each cooling ion in the trapped ion chain, as part of a side-band cooling pulse sequence, at least one analysis pulse followed by a corresponding batch with one or more side-band cooling pulses, wherein each analysis pulse is configured to determine a detuning and pulse duration of the one or more side-band cooling pulses of the corresponding batch.

A quantum computer configured to perform side-band cooling of a trapped ion chain is described that includes a trap configured to hold multiple ions of a trapped ion chain and one or more controllers. The one or more controllers are configured to apply a first cooling operation on the trapped ion chain, and apply, after the first cooling operation, a second cooling operation on the trapped ion chain that includes applying to each cooling ion in the trapped ion chain, as part of a side-band cooling pulse sequence, at least one analysis pulse followed by a corresponding batch with one or more side-band cooling pulses, wherein each analysis pulse is configured to determine a detuning and pulse duration of the one or more side-band cooling pulses of the corresponding batch.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates an example of red-side-band transition frequencies for transverse motional modes in 15-ion chain in accordance with aspects of this disclosure.

FIG. 5 illustrates an example of incremental construction of side-band cooling pulse sequences in accordance with aspects of this disclosure.

FIG. 6A illustrates an example of an analysis detuning scan in accordance with aspects of this disclosure.

FIG. 6B illustrates an example of a duration scan in accordance with aspects of this disclosure.

FIG. 7 illustrates an example of a method for the design or configuration of an optimal side-band cooling for trapped ions in accordance with aspects of this disclosure.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well-known components.

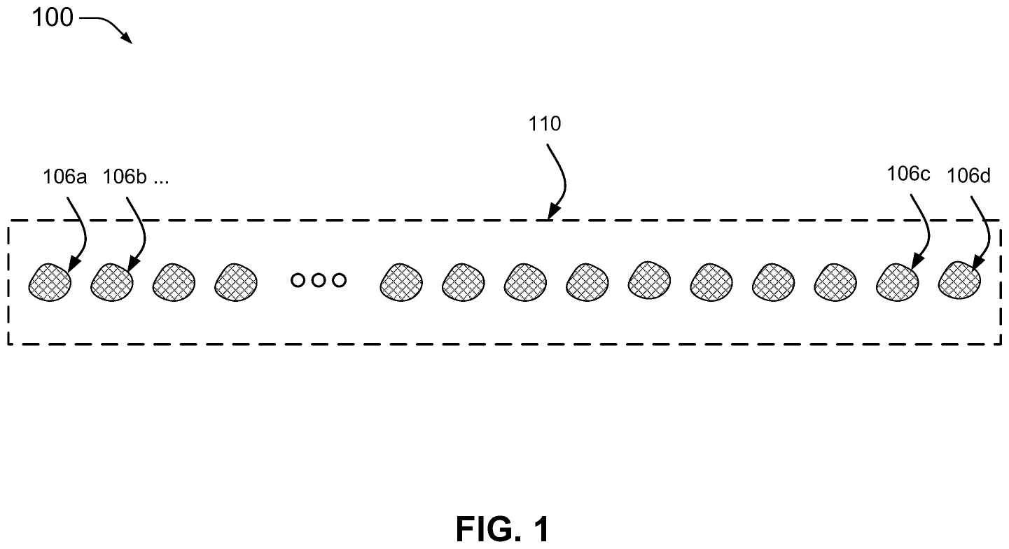

To achieve high fidelity quantum gates on trapped ion chains (see e.g., FIG. 1 below), it is necessary to reduce noise that arises from vibrational excitations, or phonons, in the modes of motion of the chain. This is achieved by side-band cooling (SBC), which further reduces the phonon temperature after an initial doppler cooling is performed. The SBC method aims at discreetly removing up to a single phonon excitation per addressed ion per side-band pulse, by driving a motional red side-band transition that also flips the qubit state of that ion (e.g., from state |0 [symbol] to state |1 [symbol] ), which is then followed by optical pumping, which resets the ion to its initial qubit state.

In a trapped ion chain, one can choose to repeat this operation using: a) fast pulses near the red side-band transitions, and b) pulses on multiple ions in parallel, to achieve more efficient removal of phonon excitations per pulse. This can help achieve SBC that is faster compared to the rate at which re-heating of the motional modes may occur, and additionally reduce run time of quantum algorithms in trapped ion multi-qubit quantum processors.

However, the dynamics of these side-band pulses can be complicated and computationally difficult to simulate. It is practical, therefore, to devise a technique that can directly measure the side-band pulse dynamics at every step of the side-band cooling sequence to incrementally design an optimal SBC pulse sequence. This makes it possible to perform on-demand calibrations of the SBC pulse sequence, tailored specifically for any given system, which is optimal in achieving near ground-state phonon temperatures, with the constraints of SBC pulses and inherent heating rate, which is specific to that system.

Solutions to the issues described above are explained in more detail in connection with FIGS. 1-7, with FIGS. 1-3 providing a background of QIP systems or quantum computers, and more specifically, of atomic-based QIP systems or quantum computers.

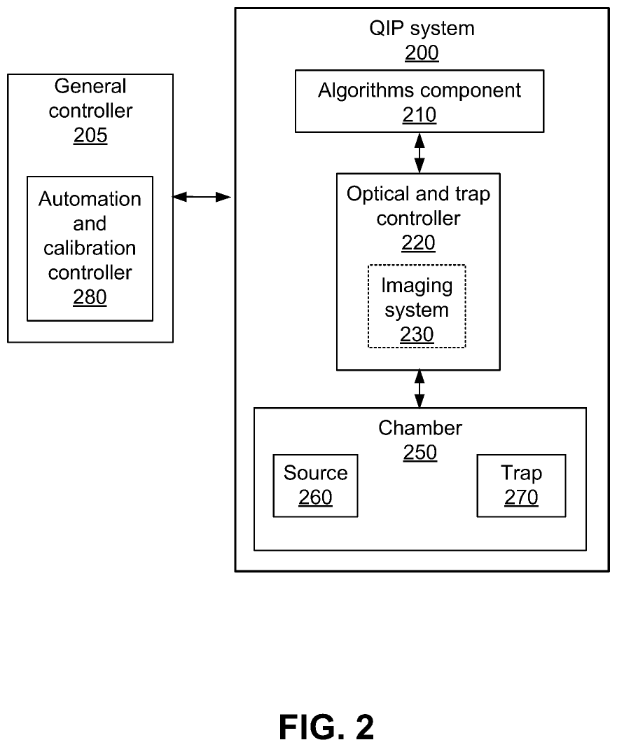

FIG. 1 illustrates a diagram 100 with multiple atomic ions or ions 106 (e.g., ions 106a, 106b, . . . , 106c, and 106d) trapped in a linear crystal or chain 110 using a trap (not shown; the trap can be inside a vacuum chamber as shown in FIG. 2). The trap maybe referred to as an ion trap. The ion trap shown may be built or fabricated on a semiconductor substrate, a dielectric substrate, or a glass die or wafer (also referred to as a glass substrate). The ions 106 may be provided to the trap as atomic species for ionization and confinement into the chain 110. Some or all of the ions 106 may be configured to operate as qubits in a QIP system.

In the example shown in FIG. 1, the trap includes electrodes for trapping or confining multiple ions into the chain 110 laser-cooled to be nearly at rest. The number of ions trapped can be configurable and more or fewer ions may be trapped. The ions can be ytterbium ions (e.g., ¹⁷¹Yb⁺ ions), for example. The ions are illuminated with laser (optical) radiation tuned to a resonance in ¹⁷¹Yb⁺ and the fluorescence of the ions is imaged onto a camera or some other type of detection device (e.g., photomultiplier tube or PMT). In this example, ions may be separated by a few microns (μm) from each other, although the separation may vary based on architectural configuration. The separation of the ions is determined by a balance between the external confinement force and Coulomb repulsion and does not need to be uniform. Moreover, in addition to ytterbium ions, barium ions, neutral atoms, Rydberg atoms, or other types of atomic-based qubit technologies may also be used. Moreover, ions of the same species, ions of different species, and/or different isotopes of ions may be used. The trap may be a linear RF Paul trap, but other types of confinement devices may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 illustrates a block diagram that shows an example of a QIP system 200. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations. The quantum and classical computations and operations may interact in such a hybrid system.

Shown in FIG. 2 is a general controller 205 configured to perform various control operations of the QIP system 200. These control operations may be performed by an operator, may be automated, or a combination of both. Instructions for at least some of the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200. These calibration, testing, and automation operations may involve, for example, all or part of an algorithms component 210, all or part of an optical and trap controller 220 and/or all or part of a chamber 250.

The QIP system 200 may include the algorithms component 210 mentioned above, which may operate with other parts of the QIP system 200 to perform or implement quantum algorithms, quantum applications, or quantum operations. The algorithms component 210 may be used to perform or implement a stack or sequence of combinations of single qubit operations and/or multi-qubit operations (e.g., two-qubit operations) as well as extended quantum computations. The algorithms component 210 may also include software tools (e.g., compilers) that facility such performance or implementation. As such, the algorithms component 210 may provide, directly or indirectly, instructions to various components of the QIP system 200 (e.g., to the optical and trap controller 220) to enable the performance or implementation of the quantum algorithms, quantum applications, or quantum operations. The algorithms component 210 may receive information resulting from the performance or implementation of the quantum algorithms, quantum applications, or quantum operations and may process the information and/or transfer the information to another component of the QIP system 200 or to another device (e.g., an external device connected to the QIP system 200) for further processing.

The QIP system 200 may include the optical and trap controller 220 mentioned above, which controls various aspects of a trap 270 in the chamber 250, including the generation of signals to control the trap 270. The optical and trap controller 220 may also control the operation of lasers, optical systems, and optical components that are used to provide the optical beams that interact with the atoms or ions in the trap. Optical systems that include multiple components may be referred to as optical assemblies. The optical beams are used to set up the ions, to perform or implement quantum algorithms, quantum applications, or quantum operations with the ions, and to read results from the ions. Control of the operations of laser, optical systems, and optical components may include dynamically changing operational parameters and/or configurations, including controlling positioning using motorized mounts or holders. When used to confine or trap ions, the trap 270 may be referred to as an ion trap. The trap 270, however, may also be used to trap neutral atoms, Rydberg atoms, and other types of atomic-based qubits. The lasers, optical systems, and optical components can be at least partially located in the optical and trap controller 220, an imaging system 230, and/or in the chamber 250.

The QIP system 200 may include the imaging system 230. The imaging system 230 may include a high-resolution imager (e.g., CCD camera) or other type of detection device (e.g., PMT) for monitoring the ions while they are being provided to the trap 270 and/or after they have been provided to the trap 270 (e.g., to read results). In an aspect, the imaging system 230 can be implemented separate from the optical and trap controller 220, however, the use of fluorescence to detect, identify, and label ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of what may be referred to as a processor or processing portion of the QIP system 200. That is, the trap 270 may be considered at the core of the processing operations of the QIP system 200 since it holds the atomic-based qubits that are used to perform or implement the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the general controller 205, the automation and calibration controller 280, and/or the optical and trap controller 220.

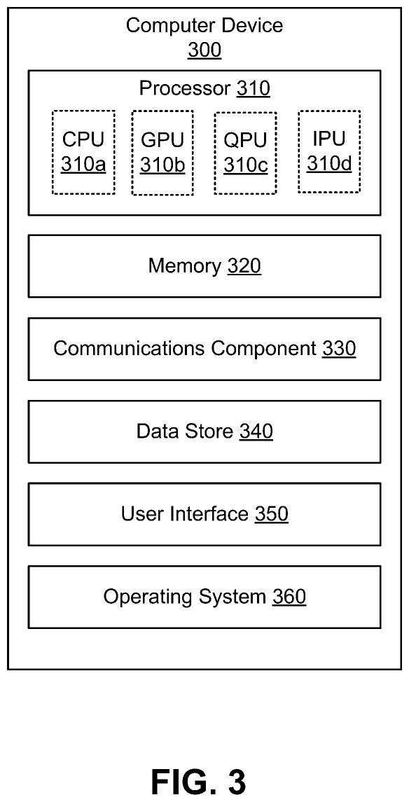

Referring now to FIG. 3, an example of a computer system or device 300 is shown. The computer device 300 may represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single processor, multiple set of processors, or one or more multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300). Quantum operations may be performed by the QPUs 310c. Some or all of the QPUs 310c may use atomic-based qubits, however, it is possible that different QPUs are based on different qubit technologies.

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In connection with the systems described in FIGS. 1-3, the present disclosure describes a technique for optimizing the SBC pulse sequence to achieve acceptable levels of phonon temperatures relatively fast, thereby allowing for the design or configuration of an optimal side-band cooling of trapped ions for QIP systems. As such, a technique with multiple steps is described below for calibrating or configuring the SBC pulses.

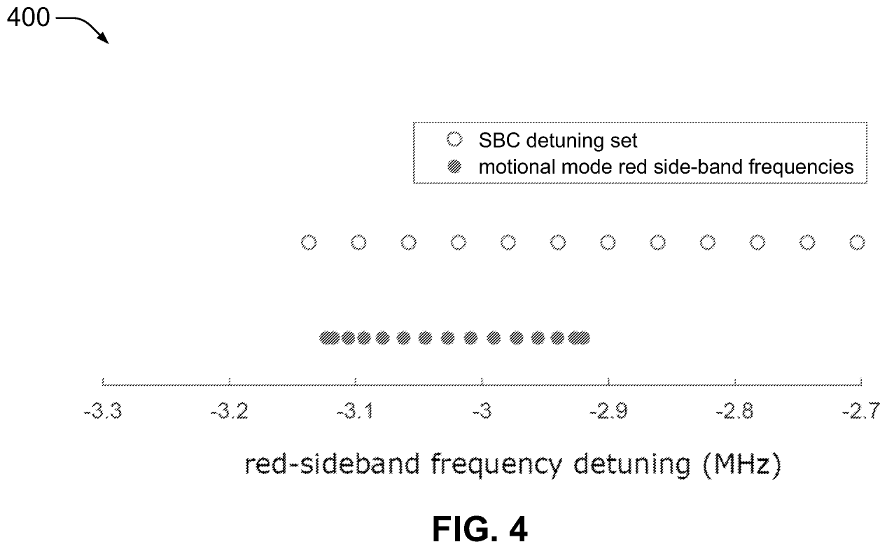

In a first step (or step 1), the technique involves applying a side-band pulse to the cooling qubits and scanning the detuning over an SBC detuning set that spans the red side-band spectrum (i.e., frequencies) of motional modes, which are to be side-band cooled. It is possible to experiment with how densely (e.g., evenly) spaced the detunings in the SBC detuning set need to be. In a diagram 400 in FIG. 4, the motional mode red side-band frequencies are shown by solid circles and the SBC detuning set is shown by the white circles.

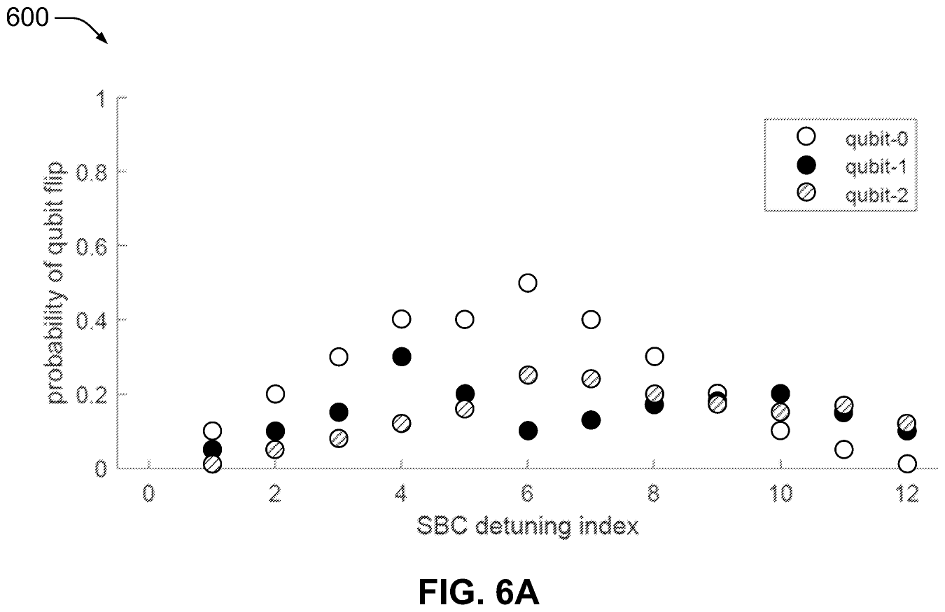

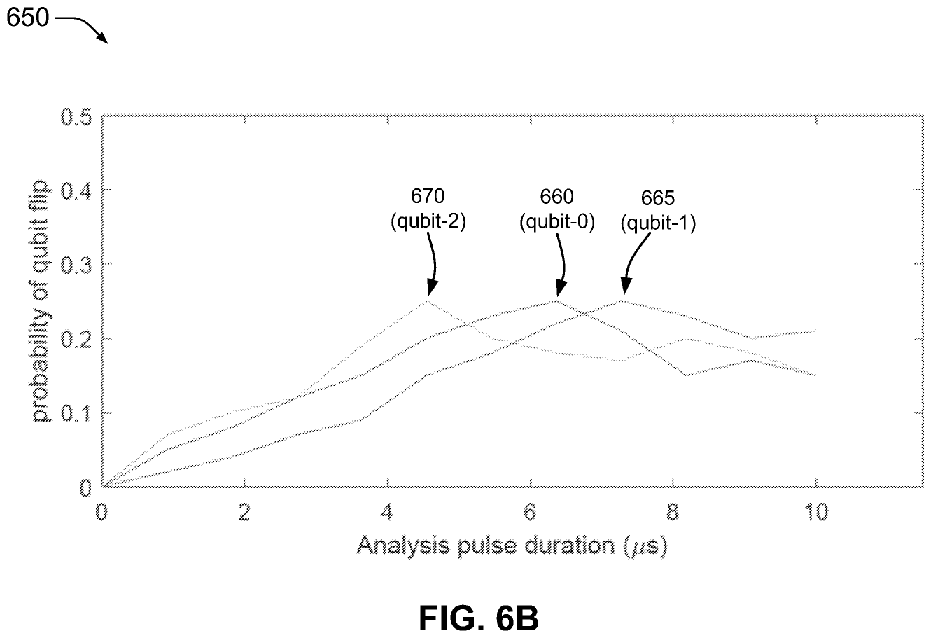

The side-band pulse used to probe the detuning response is referred to as the analysis pulse and its duration can be chosen to ensure that the extent of qubit flip (say from initial state |0 [symbol] to state |1 [symbol] ) represents the extent of removal of phonons. Based on the qubit flip response of each cooling qubit across the scanned detunings, an optimal set of detunings assignments can be made for each qubit to ensure the highest rate of removal of phonon excitations per SBC pulse (see e.g., FIG. 6A).

In a second step (or step 2), the technique further involved performing a duration scan by applying in parallel an analysis pulse on each cooling qubit at the assigned detunings from the first step outlined above. Here the optimal pulse duration for each qubit where maximum qubit flip happens is identified, which also represents the shortest pulse duration required to remove the greatest number of phonons per pulse (see e.g., FIG. 6B).

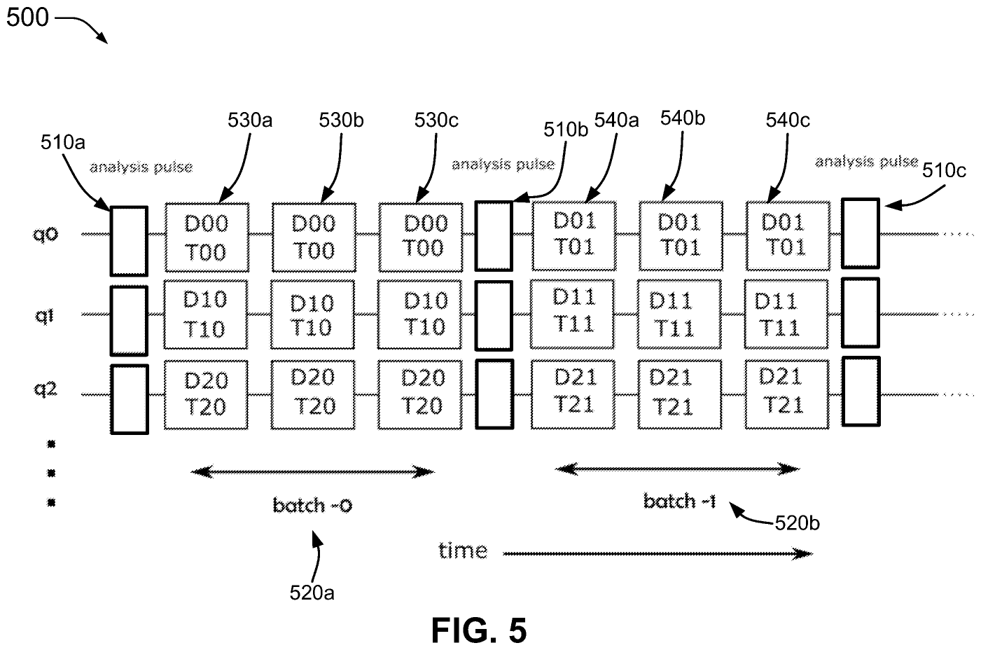

In a third step (or step 3), the technique further involves defining a batch of successive SBC and optical pumping pulse combinations as determined from steps 1 and 2 above. The batch length can be between one and a few repetitions (see e.g., FIG. 5).

In a fourth step (or step 4), to incrementally design an SBC pulse sequence, the technique further involves applying a partial SBC sequence consisting of already optimized pulse sequence batches (based on steps 1-3) followed by the next round of analysis pulse, where steps 1 and 2, are repeated. In other words, the technique involves finding an optimal detuning and duration assignments of cooling qubits for each batch of SBC pulses based on the cooling achieved from the previously designed SBC batches (see e.g., FIG. 5).

In a fifth step (or step 5), the technique further involves additionally using the degree of qubit flip in detuning and duration analysis pulses as an indicator of the reduction of phonon temperature, where the lower qubit flip indicates a lower phonon temperature achieved. Based on this, it is possible to decide or determine the length of the SBC pulse sequence, thereby minimizing overall time, keeping it only as long as necessary for achieving an acceptable low temperature.

In a sixth step (or step 6), the technique further involves identifying that the pump duration during an SBC sequence can be reduced to further reduce total SBC duration. The limit to this can be set by making sure that the final temperature as estimated in step 5 is maintained, while varying the duration of optical pumping pulses.

Returning to the diagram 400 in FIG. 4, an example of red-side-band transition frequencies for transverse motional modes in a 15-ion chain is shown with the motional mode red side-band frequencies in solid circles (e.g., 15 solid circles) and the SBC detuning set in white circles (e.g., 12 white circles) as mentioned above. This is an example of a typical spectrum of motional modes that could be cooled using the SBC technique disclosed herein. The solid circles show an arbitrarily chosen evenly spaced SBC detuning set that spans the motional mode spectrum and can be used as applied detuning points in the detuning scan as stated in step 1 of the technique.

In connection with the steps described above, FIG. 5 shows a diagram 500 that illustrates an example of incremental construction of side-band cooling pulse sequences using the SBC technique disclosed herein.

In the diagram 500, an analysis pulse is applied on each qubit (participating in SBC), here shown by at least qubits q0-q2, to obtain the optimal detuning and duration to be applied in any given batch of SBC pulses. Dij, and Tij, represent the side-band detuning frequency and side-band duration of each pulse in a batch, respectively, and are applied on qubit i in batch j. Analysis pulses which would be used to determine detunings and pulse durations for the N-th SBC batch, are applied after a partial SBC sequence containing N−1 preceding batches. In other words, a new analysis pulse precedes a corresponding batch as the overall SBC pulse sequence is being constructed.

In this example, for q0 or qubit-0, a first analysis pulse 510a is applied to obtain the optimal side-band detuning frequency and optimal side-band pulse duration for the pulses applied in a first batch 520a (batch-0) that follows the first analysis pulse 510a. During the first batch 520a, pulses 530a, 530b, and 530c are applied, each having a side-band tuning frequency D00 and a side-band pulse duration of T00. After the firs batch 520a, a second analysis pulse 510b is applied to obtain the optimal side-band detuning frequency and optimal side-band pulse duration for the pulses applied in a second batch 520b (batch-1) that follows the second analysis pulse 510b. During the second batch 520b, pulses 540a, 540b, and 540c are applied, each having a side-band tuning frequency D01 and a side-band pulse duration of T01. Additional analysis pulses may be used (e.g., a third analysis pulse 510c) to further extend the SBC pulse sequence.

A similar approach to that described above for q0 may be applied to q1 (qubit-1) and q2 (qubit-2), and to any other qubit that is participating in SBC. Note that the analysis pulses, batches, and corresponding pulses are temporarily aligned or synchronized for all SBC participating qubits.

Further in connection with the steps described above, FIG. 6A shows a diagram 600 that illustrates an example of an analysis detuning scan and FIG. 6B shows a diagram 650 that illustrates an example of a duration scan.

The detuning scan in the diagram 600 in FIG. 6A scans the analysis pulse, applied to each qubit (e.g., qubit-0, qubit-1, qubit-2), though a set of SBC detunings (see e.g., FIG. 4). The duration scan in the diagram 650 in FIG. 6B applies analysis pulses on all the qubits (q0-q2) in parallel, after having set the detunings of each to an optimal detuning as determined by the detuning scan in the diagram 600. The duration of the SBC pulses per qubit can, for example, be set to the value at which qubit flip maximizes, for that qubit. In the diagram 650, the value at which each qubit flip maximizes is shown by an arrow pointing to the maximum value, with value 660 corresponding to the maximum value for the curve for qubit-0, value 665 corresponding to the maximum value for the curve for qubit-1, and value 670 corresponding to the maximum value for the curve for qubit-2.

Additional details related to the technique or method described herein for designing or configuring an optimal side-band cooling sequence of pulses for trapped ions are provided below, with appropriate reference made to any of FIGS. 1-6B.

The technique disclosed herein provides for the calibration or configuration of side-band cooling for trapped ions and can be used from cooling local modes to cooling in a regime that is much slower that cooling in the local modes and cooling in the normal modes. This technique is intended to be very robust on how fast or how slow to go based on the optical power budget that is available to drive the side-band transition steps. It is also customizable based on how many of the ions in the trapped ion chain (see e.g., FIG. 1 above) are or can be used to cool the entire chain. In other words, it is possible to select the number of ions in a chain that are used for cooling.

The technique disclosed herein allows for the design or configuration of the pulse sequence for side-band cooling in a step-by-step manner so that it is possible to optimize at every level of the pulse and keep the total pulse duration the shortest that is needed to make sure that the qubit cooling of the trap ion chain is optimal. Optimally in this context may refer to driving the qubit at the correct frequency and at the right duration.

In general, side-band cooling is used broadly for cooling in ion trapping, and thus in QIP systems that are based on trapped ions for qubits. When it comes to trapped ions and quantum processing, the general goal is to provide cooling more efficiently. There may be limitations in terms of which qubits to use and how much optical power there is available for cooling, and techniques are needed that allow for the design or configuration of an optimal side-band cooling approach for a particular system based on the constraints of that system.

The technique described herein can be used with QIP systems that allow for the customization of frequency and duration of a side-band cooling pulse sequence. That is, this technique can be used in systems that allow for each qubit to be addressed individually. Some systems enable this individual addressability by using acousto-optic modulators (AOMs) with multiple, independent channels. Same functionality may be achieved by using electro-optic modulators (EOMs), electro-optic deflectors (EODs), and/or acousto-optic deflectors (AODs). Thus, this technique can be used with various kinds of architectures for addressing qubits to do Raman transitions and side-band cooling.

A more detailed description associated with the steps used in the technique described herein for designing or configuring an optimal side-band cooling for trapped ions is provided next. There is an initial chain of ions (e.g., chain 110 of ions 106 in FIG. 1) and there is a subset of the ions in the chain that are going to be used to drive side-band cooling. The first thing to do is to cool the entire chain using Doppler cooling. To implement gates, however, this is not sufficient, and the chain needs to be cooled further. This is generally referred to as sub-Doppler cooling and is achieved by using side-band cooling. What that does is that it starts coherent transitions, so basically transitions that flip the state from, for example, |0 [symbol] to |1 [symbol] , of the qubit but it is detuned to the so-called red side-band transition so that when the qubit is flipped it removes vibration of excitation from the motional modes (removes phonons).

By driving several qubits in the chain in this fashion it is possible to remove several phonons at any given time. The general approach is then to flip the qubit and remove phonons, then apply optical pumping, which is shine a different laser that resets the qubit state from |1 [symbol] back to |0 [symbol] . At this point, the process can be repeated and are ready to remove another set of phonons by flipping the qubit again from |0 [symbol] to |1 [symbol] . This repeated sequence of red side-band pulse and optical pumping, this repeated sequence pair, constitutes a side-band cooling routine.

In the technique described herein, for a system that has, for example, 15 qubits, it is possible to use a subset of those qubits for side-band cooling the entire chain. In one example, 5 out of the 15 qubits may be used for side-band cooling. The technique then involves finding out or determining the side-band pulse that is required to drive each one of the qubits, that is, the frequency and duration for each pulse. Then the pulse is applied, and optical pumping is also applied, but before applying the next pulse, the technique involves determining or measuring the next set of detunings or frequencies for each qubit and the duration that needs to be applied for the second pulse. The entire side-band cooling sequence is therefore constructed or configured on a pulse-by-pulse basis (or on a batch-by-batch of pulses basis).

A conceptual schematic representation of this technique is shown in the diagram 500 in FIG. 5. The technique uses an analysis pulse, which is a pulse that is at the red side-band frequency and scan the frequency over a few detuning points (see e.g., FIG. 4 where the solid circles are the SBC detuning points). The set of frequencies usually span the set of frequencies of the motional spectra that the system is trying to cool. In the example of a 15-ion chain, there would be 15 motional modes and there would be frequencies such as the ones represented by the white circles in FIG. 4. To cool down these modes, a detuning that is near these modes will be needed. Which detuning is best is not known so a scan over a set of detunings is needed to find out where is the best detuning. The set of detunings can be chosen and experiments may be used to select an appropriate set of detunings. In the example in FIG. 4, the detunings are evenly spaced but that need not be the case and different spacing can be used between detunings in a set.

For each qubit that is being used for side-band cooling, a pulse is applied that drives the side-band transition, which would basically flip the qubit state from |0 [symbol] to |1 [symbol] . And it is going to step through each of the detunings to find out at which detuning the probability of flipping is at a maximum. In the example illustrated in the diagram 600 in FIG. 6A, there are 3 qubits (qubit-0 in white, qubit-1 in black/solid, and qubit-2 in hash pattern). For qubit-0 an analysis pulse is applied, and the detuning response is shown. The detuning causes the spin to flip, and the extent of the spin flip tells how much or how many phonons are removed (how many vibrational excitations are removed). In the example in FIG. 6A, it appears that qubit-0 has a peak at 6 in the detuning index, qubit-1 at 4, and qubit-2 at 6. These are the detunings at which qubit-0, qubit-1, and qubit-2 need to be set to remove the maximum number of phonons in a single pulse. This is what the analysis pulse is intended to determine. The terms detuning and frequency may be used interchangeably in the context of this technique.

When performing a side-band cooling, such a pulse would be needed for some duration of time, and this would be done in parallel on all qubits so that as many phonons are removed in parallel as quickly as possible. Thus, the next thing to determine is the duration of this pulse.

Referring to the diagram 650 in FIG. 6B, the figure illustrates the minimal duration for removing the greatest number of phonons in qubit-0, qubit-1, and qubit-2, and the pulse that is to be applied to each qubit needs to be applied according to the appropriate duration. Duration can again be set to the value at which the qubit flip maximizes. In this example, it appears that qubit-0 has a peak at 6 μs (value 660), qubit-1 at 7 μs (value 665), and qubit-2 at 4 μs (value 670).

After the side-band transition, next would be the application of optical pumping and then the pulses again to remove another round of vibrational excitations.

Referring back to the diagram 500 in FIG. 5, the figure introduces the concept of a batch, which has been described above. A batch in this context may refer to a repetition of pulses determined by an analysis pulse routine. In the example in FIG. 5 there are three pulses repeated in a row, but other examples may involve more (5 pulses in a row) or fewer pulses in a row (as few as a single pulse). The concept of the batch is because multiple pulses may be needed to remove phonons before a change is noticeable in the detuning and duration response. This makes this calibration procedure faster. For example, experimentation has shown that it may take 2-5 pulse repetitions before there are any new requirements of the side-band pulse duration and detuning. As shown in FIG. 5, after the first batch 20a (batch-0) another analysis pulse is performed to find out the new detuning and duration with a now partially cooled chain. The new detuning and duration are then applied to the pulses in the next batch, the second batch 520b (batch-1).

The approach outlined about is how the side-band cooling pulse sequences are incrementally constructed or configured. With the approach to use for construction the pulse sequences outlined, the next step is to determine a few aspects of the technique that can be optimized. One of the aspects to optimize is the number of batches to be performed, or in other words, how many batches to perform before stopping. The side-band cooling may not need to be kept going for a long time as there may be intrinsic heating rates that excite phonons and longer cooling may result in diminishing returns. The side-band cooling may need to be kept only as it is desirable for a particular system.

For determining the batch size, it is important to recall that the analysis pulse is used to look at the detuning scan response and the duration scan response to see where the qubit flip probability maximizes, which in turn is an indirect measurement of the temperature of the trapped ion chain. As this is done repeatedly, the scans start to show a lower value of the qubit flip probability maximum, which indicates that the side-band cooling has cool the chain a lot and it is probably a good point to stop. This can be used as an indicator of the optimized length of the side-band cooling pulse sequence, and thus the number of batches to use.

Moreover, the optical pumping that occurs between side-band cooling pulses also contributes to the overall duration of the side-band cooling sequence. The number of optical pumping pulses is the same as the number of side-band cooling pulses. If it is possible to reduce the overall optical pumping time, then the overall duration of the side-band cooling sequence is also reduced. Optical pumping is typically set to a high value because that improves the fidelity of the state initialization. But it turns out that for side-band cooling that needs not be done to a high degree of accuracy. Side-band cooling only requires that the qubit state be reset to |0 [symbol] enough to remove the next phonon when the qubit flips. It is therefore possible to start reducing the optical pumping duration in this protocol to find out when it is too short that it starts hurting the results, that is, where the temperature is not being reduced enough anymore. By optimizing the optical pumping pulse duration, it is possible to further reduce the overall duration of the side-band cooling sequence.

Another consideration is how strongly is the side-band cooling transition being driven. By using more optical power the side-band cooling transition can be driven faster. Changes in the optical power for side-band cooling are considered when the duration pulse is determined for each qubit, whether it is a decrease in power because of laser and/or optics degradation, or changes because different systems have different power levels.

Detuning scan responses and duration scan responses can provide some insight into the amount of power available to the system for side-band cooling. If the power is very low, the detuning response is likely to have very sharp features, and if the power is high, the detuning response is likely to be flat. That is because a high power to drive a transition will drive all motional transitions together and it matters less where you detune. A low power will predominantly drive one motional transition at a time because it is relatively more detuned from other motional transitions, and thus sharper results.

Thus, by looking at the detuning response, if there is enough power and the detuning response is flat, the side-band sequence will be robust and will not matter much if the motional modes were drifting in frequency. It is possible to reduce the power and look at the detuning and duration responses to see if the reduced power is still efficient to cool down the modes and reach the desired temperature. In such a case, having a system with reduced power will not be a problem.

The technique described herein can be considered a calibration technique, which means that as certain factors or properties in the system change, it is possible to determine the needed detuning and duration information for new side-band cooling pulses. As mentioned above, some of these factors or properties include the Rabi frequency (e.g., intensity of the laser that drives the side-band transition). In this case, if the side-band laser intensity has increased or decreased, the technique or calibration described herein can be used to determine the optimal pulse for the side-band cooling.

Another factor or property to consider is the number of qubits available for side-band cooling. In a 15-ion chain, it is possible to do it with 3 qubits (and determine an optimal pulse for 3 qubits), then change it to 11 qubits (and determine a new, optimal pulse for 11 qubits), and then back down to 9 qubits if 2 become unavailable (and again determine a new, optical pulse for 9 qubits).

Another factor or property to consider is the optical pump duration, as described above.

Another factor or property to consider is the heating rate of the motional modes. The goal is to achieve an equilibrium point between the desired temperature and the heating rate. Any change in the heating rate can prompt the start of this calibration technique.

Another factor or property to consider is the Doppler cooling efficiency. Because Doppler cooling is performed with a different laser, if the power of that laser changes the Doppler cooling efficiency can change. Because the side-band cooling starts at a temperature achieved by Doppler cooling, if the Doppler cooling efficiency changes the starting temperature for side-band cooling changes and side-band cooling calibration may be needed.

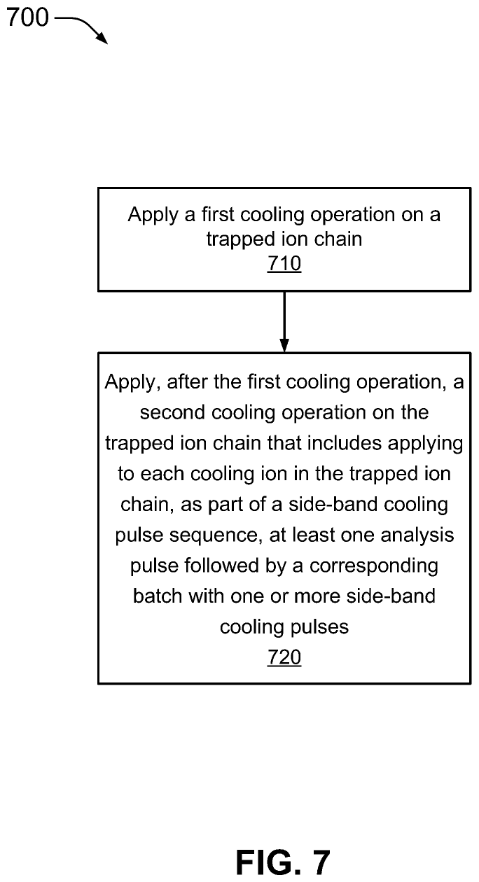

FIG. 7 illustrates an example of a method 700 for the design or configuration of an optimal side-band cooling for trapped ions. At 710, the method 700 includes applying a first cooling operation on the trapped ion chain.

At 720, the method 700 includes applying, after the first cooling operation, a second cooling operation on the trapped ion chain that includes applying to each cooling ion in the trapped ion chain, as part of a side-band cooling pulse sequence, at least one analysis pulse followed by a corresponding batch with one or more side-band cooling pulses, wherein each analysis pulse is configured to determine a detuning and pulse duration of the one or more side-band cooling pulses of the corresponding batch.

In an aspect of the method 700, the first cooling operation is a Doppler cooling operation.

In an aspect of the method 700, applying the analysis pulse to each cooling ion includes performing a detuning scan to determine the detuning based on a value corresponding to a maximum probability of a qubit flip. The detuning scan is based on a detuning set that spans red side-band transition frequencies for transverse motional modes in the trapped ion chain. The detuning set includes evenly spaced frequencies.

In an aspect of the method 700, applying the analysis pulse to each cooling ion includes performing a duration scan to determine the pulse duration based on a value corresponding to a maximum probability of a qubit flip.

In an aspect of the method 700, a number of cooling ions in the trapped ion chain is less than a total number of ions in the trapped ion chain. Moreover, the number of cooling ions in the trapped ion chain for the side-band cooling pulse sequence may vary based on when the side-band cooling pulse sequence is applied.

In an aspect of the method 700, the one or more side-band cooling pulses of the corresponding batch includes between 1 and 5 side-band cooling pulses.

In an aspect of the method 700, the method 700 further comprises performing one or more quantum computations using the trapped ion chain after applying the side-band cooling pulse sequence as part of the second cooling operation.

An example of a quantum computer or QIP system configured to perform side-band cooling of a trapped ion chain is described that includes a trap (e.g., trap 270 in FIG. 2) configured to hold multiple ions in a trapped ion chain, and one or more controllers (e.g., general controller 205, automation and calibration controller 280, and/or optical and trap controller 220). The one or more controllers are configured to apply a first cooling operation on the trapped ion chain and apply, after the first cooling operation, a second cooling operation on the trapped ion chain that includes applying to each cooling ion in the trapped ion chain, as part of a side-band cooling pulse sequence, at least one analysis pulse followed by a corresponding batch with one or more side-band cooling pulses, wherein each analysis pulse is configured to determine a detuning and pulse duration of the one or more side-band cooling pulses of the corresponding batch.

In an aspect of the quantum computer, the first cooling operation is a Doppler cooling operation.

In an aspect of the quantum computer, the one or more controllers configured to apply the analysis pulse to each cooling ion are further configured to perform a detuning scan to determine the detuning based on a value corresponding to a maximum probability of a qubit flip. The detuning scan is based on a detuning set that spans red side-band transition frequencies for transverse motional modes in the trapped ion chain. The detuning set includes evenly spaced frequencies.

In an aspect of the quantum computer, the one or more controllers configured to apply the analysis pulse to each cooling ion are further configured to perform a duration scan to determine the pulse duration based on a value corresponding to a maximum probability of a qubit flip.

In an aspect of the quantum computer, a number of cooling ions in the trapped ion chain is less than a total number of ions in the trapped ion chain. The number of cooling ions in the trapped ion chain for the side-band cooling pulse sequence may vary based on when the side-band cooling pulse sequence is applied.

In an aspect of the quantum computer, the one or more side-band cooling pulses of the corresponding batch includes between 1 and 5 side-band cooling pulses.

In an aspect of the quantum computer, the quantum computer may further include an algorithms component (e.g., algorithms component 210) configured to perform one or more quantum computations using the trapped ion chain after applying the side-band cooling pulse sequence as part of the second cooling operation.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method for side-band cooling a trapped ion chain, comprising:
applying a first cooling operation on the trapped ion chain; and
applying, after the first cooling operation, a second cooling operation on the trapped ion chain that includes applying to each cooling ion in the trapped ion chain, as part of a side-band cooling pulse sequence, at least one analysis pulse followed by a corresponding batch with one or more side-band cooling pulses, wherein the at least one analysis pulse is configured to determine a detuning and pulse duration of the one or more side-band cooling pulses of the corresponding batch.

2. The method of claim 1, wherein the first cooling operation is a Doppler cooling operation.

3. The method of claim 1, wherein applying the at least one analysis pulse to each cooling ion in the trapped ion chain includes performing a detuning scan to determine the detuning based on a value corresponding to a maximum probability of a qubit flip.

4. The method of claim 3, wherein the detuning scan is based on a detuning set that spans red side-band transition frequencies for transverse motional modes in the trapped ion chain.

5. The method of claim 4, wherein the detuning set includes evenly spaced frequencies.

6. The method of claim 1, wherein applying the at least one analysis pulse to each cooling ion in the trapped ion chain includes performing a duration scan to determine the pulse duration based on a value corresponding to a maximum probability of a qubit flip.

7. The method of claim 1, wherein a number of cooling ions in the trapped ion chain is less than a total number of ions in the trapped ion chain.

8. The method of claim 7, wherein the number of cooling ions in the trapped ion chain for the side-band cooling pulse sequence varies based on when the side-band cooling pulse sequence is applied.

9. The method of claim 1, wherein the one or more side-band cooling pulses of the corresponding batch includes between 1 and 5 side-band cooling pulses.

10. The method of claim 1, further comprising performing one or more quantum computations using the trapped ion chain after applying the side-band cooling pulse sequence as part of the second cooling operation.

11. A quantum computer configured to perform side-band cooling of a trapped ion chain, comprising:
a trap configured to hold multiple ions in a trapped ion chain; and
one or more controllers configured to:
apply a first cooling operation on the trapped ion chain; and
apply, after the first cooling operation, a second cooling operation on the trapped ion chain that includes applying to each cooling ion in the trapped ion chain, as part of a side-band cooling pulse sequence, at least one analysis pulse followed by a corresponding batch with one or more side-band cooling pulses, wherein the at least one analysis pulse is configured to determine a detuning and pulse duration of the one or more side-band cooling pulses of the corresponding batch.

12. The quantum computer of claim 11, wherein the first cooling operation is a Doppler cooling operation.

13. The quantum computer of claim 11, wherein the one or more controllers configured to apply the at least one analysis pulse to each cooling ion are further configured to perform a detuning scan to determine the detuning based on a value corresponding to a maximum probability of a qubit flip.

14. The quantum computer of claim 13, wherein the detuning scan is based on a detuning set that spans red side-band transition frequencies for transverse motional modes in the trapped ion chain.

15. The quantum computer of claim 14, wherein the detuning set includes evenly spaced frequencies.

16. The quantum computer of claim 11, wherein the one or more controllers configured to apply the at least one analysis pulse to each cooling ion in the trapped ion chain are further configured to perform a duration scan to determine the pulse duration based on a value corresponding to a maximum probability of a qubit flip.

17. The quantum computer of claim 11, wherein a number of cooling ions in the trapped ion chain is less than a total number of ions in the trapped ion chain.

18. The quantum computer of claim 17, wherein the number of cooling ions in the trapped ion chain for the side-band cooling pulse sequence varies based on when the side-band cooling pulse sequence is applied.

19. The quantum computer of claim 11, wherein the one or more side-band cooling pulses of the corresponding batch includes between 1 and 5 side-band cooling pulses.

20. The quantum computer of claim 11, further comprising an algorithms components configured to perform one or more quantum computations using the trapped ion chain after applying the side-band cooling pulse sequence as part of the second cooling operation.
